(19) United States
(12) Patent Application Publication
(10) Pub. No.: US 2021/0000292 A1
(43) Pub. Date: Jan. 7, 2021

(54) COMBINED AIR FRYER AND PRESSURE COOKER LID

(71) Applicant: Sunbeam Products, Inc., Boca Raton, FL (US)

(72) Inventors: KK Siu, Ma On Shan (HK); Sam Ho, Tseung Kwan O (HK); Samuel But, Shatin (HK)

(21) Appl. No.: 16/915,441

(22) Filed: Jun. 29, 2020

Related U.S. Application Data
(60) Provisional application No. 62/869,804, filed on Jul. 2, 2019.

(51) Int. Cl. A47J 36/10; A47J 27/08; A47J 37/06

(52) U.S. Cl. CPC A47J 36/10; A47J 27/0813; A47J 37/0664; A47J 37/0641; A47J 27/0815

(57) ABSTRACT

The present invention provides a combination pressure cooker and air fryer including a lid that may be selectively attached to a vessel. The lid may be adjustable between two general cooking positions. In the first cooking position, the lid may operate with the vessel as a pressure cooker. In the second cooking position, the may operate with the vessel as an air fryer. In performing either of the pressure cooking or air fryer cooking functions, the lid does not need to be replaced.

### CROSS-REFERENCE TO RELATED APPLICATIONS

This Application claims priority to U.S. Provisional Patent Application Ser. No. 62/869,804, filed on Jul. 2, 2019, entitled “COMBINED AIR FRYER AND SLOW COOKER WITH A SINGLE LID” currently pending, the entire disclosure of which is incorporated herein by reference.

### FIELD OF THE INVENTION

The invention refers to a kitchen appliance. More specifically, this invention refers to a kitchen appliance that may be used as either a pressure cooker or air fryer, and includes a single vessel and lid.

### BACKGROUND OF THE INVENTION

Many consumers keep a wide variety of kitchen appliances that are tailored to carry out particular cooking functions. For example, many consumers have pressure cookers that can be used to steam or cook food in liquid. Such pressure cookers may substantially reduce cook time.

Consumers also may utilize deep fryers or air fryers to make foods such as potato chips, fried chicken, fish, French fries, or pastries. However, air fryers usually use 70-80% less oil than a traditional deep fryer and are thought of as more healthy. As a result, air fryers have become more commonplace in homes over the past several years.

Many consumers view both pressure cookers and air fryers as necessary appliances due to their usefulness and effectiveness. However, both appliances require storage space when not in use. Given the number of other appliances that a consumer may employ and store (e.g., blenders, food processors, hand and stand mixers, rice cookers), kitchens quickly run out of storage space. As a result, consumers may struggle to find storage space for pressure cookers and air fryers.

Because pressure cooking requires an airtight seal between a lid and vessel, and air frying requires airflow between the lid and vessel and ambient air, it is quite difficult for a single appliance to perform both functions. Current “solutions” to this issue on the market make use of two separate lids that can be used with the same vessel. The first lid can perform pressure cooking functions, while the second lid can perform air frying functions. However, this “solution” defeats the purpose of providing an appliance that can perform both functions since a consumer would need to store each of the two lids, which can be quite clumsy and burdensome. In short, storing two lids does not save enough space in the limited storage space most consumers have in their kitchens. It is therefore desirable for a simply constructed appliance to operate as each of a pressure cooker and air fryer, without the need for additional components.

### SUMMARY OF THE INVENTION

The present invention provides a combination pressure cooker and air fryer lid that may be attached to a vessel containing a food item. The lid may be adjustable between two general cooking positions. In the first cooking position, the lid may operate with the vessel as an air fryer. In the second cooking position, the may operate with the vessel as a pressure cooker. In performing either of the air fryer or pressure cooking functions, the lid need not be replaced.

In the invention, a lid is provided that may be attached to a cooking vessel using a variety of known or foreseeable methods and mechanisms. The lid includes a slider member in mechanical connection with a first linear gear. The first linear gear is a rack of a rack and pinion actuator. The pinion of that system is provided as a circular gear in mechanical connection with the first linear gear. The pinion is further in mechanical connection with a second linear gear that makes up a side portion of a clamp member that may secure (and unsecure) the lid to the vessel. As such, when the slider member is slid in a first direction, the rack and pinion (or first linear gear and circular gear, respectively) operate together to translate the second linear gear and thus the clamp member inwardly.

With the clamp member drawn inwardly, it is drawn away from a lip member around a circumference of the lid that the clamp member mates with when the lid is in its second, pressure cooking position, which will be described below. In the first position with the firm attachment between the lid and the vessel created by the clamp members eliminated, air communication between the vessel and the environment is created to help facilitate the air frying process. On an underside of the lid, a fan is provided that helps circulate the air used during air frying.

When slider member is slid in a second direction, the first linear gear and the circular gear operate in the opposite directions that they did in the first direction. As such, they also cause the second linear gear and the clamp member to move in an opposite direction as compared to its movement when the slider member was in its first position. The clamp member is thus translated outwardly such that it engages with the lip member of the lid so as to firmly secure the lid to the vessel. In this position, the vessel may be airtight for its pressure cooking mode. In the pressure cook mode a protective cap member may be placed over the fan that was used for air frying mode so that the fan is protected from food that may splatter upwardly toward the fan and damage the fan or otherwise reduce its efficacy when it is used for air frying.

Sensors may be present in the lid that detect when the lid is in its first or second position. The sensors may be in communication with a microcontroller that may instruct the lid to carry out particular functions associated with air frying or pressure cooking, depending on the position of the slider member, user input, or both.

### BRIEF DESCRIPTION OF THE DRAWINGS

For a better understanding of the various embodiments of the present invention, reference may be made to the accompanying drawings in which:

FIG. 1 is a perspective view of a combined air fryer and pressure cooker constructed according to the teachings of the present invention in a first position;

FIG. 2 is an exploded view of the combined air fryer and pressure cooker of FIG. 1 in the first position;

FIG. 3 is a top perspective view of a lid for the combined air fryer and pressure cooker of FIGS. 1 and 2 in the first position;

FIG. 4 is a bottom perspective view of the lid of FIG. 3 in the second position;

FIG. 5 is a top perspective view of the lid of FIGS. 3 and 4 in a second position;

FIG. 6 is a bottom perspective view of the lid of FIGS. 3-5 in the second position;

FIG. 7 is a top perspective view of the lid of FIGS. 3-6 in a third position;

FIG. 8 is a bottom perspective view of the lid of FIGS. 3-7 in the third position;

While the disclosure is susceptible to various modifications and alternative forms, specific embodiments thereof are shown by way of example in the drawing and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be understood that any dimensions included in the figures are simply provided as examples and dimensions other than those provided therein are also within the scope of the invention.

The description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

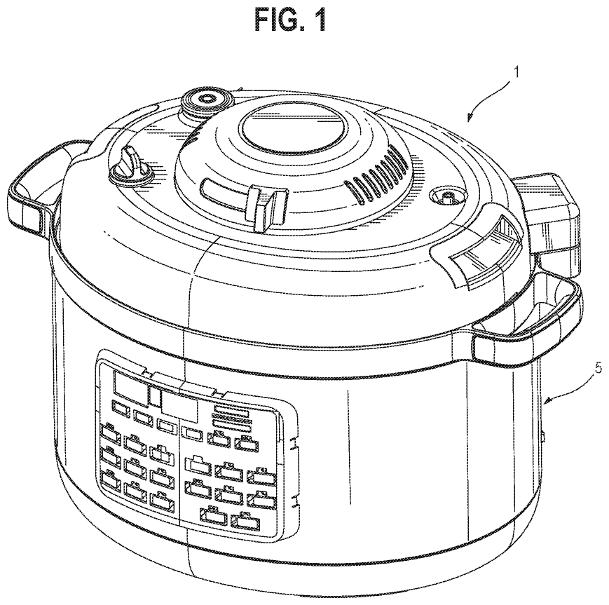

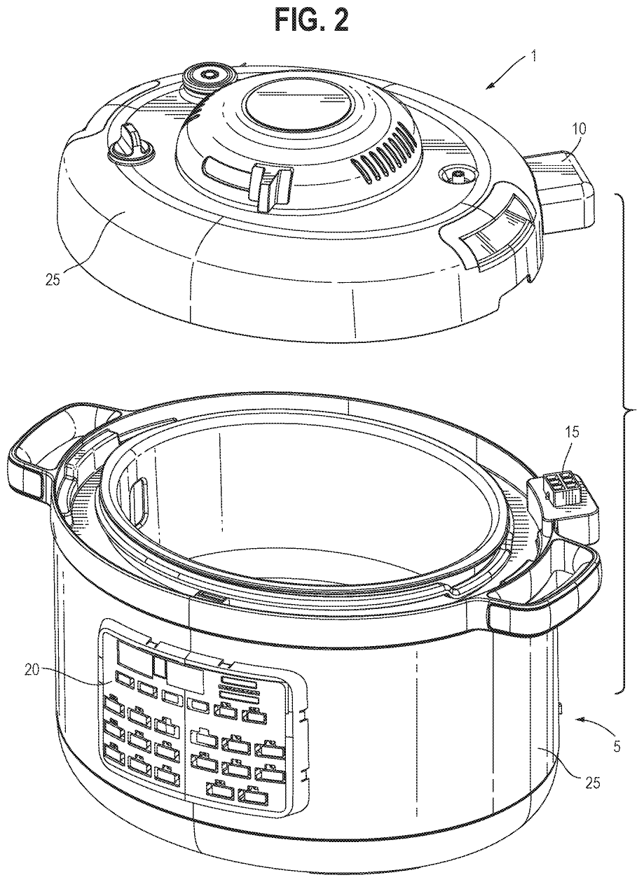

FIGS. 1 and 2 depict a lid member 1 and a vessel 5 that together may perform at least two cooking functions. Such cooking functions may be carried out in association with a number of different types of food products. More particularly, the lid member 1 may be selectively attachable to the vessel 5, and together they may be used as an air fryer or pressure cooker. Each of the lid member 1 and the vessel 5 may include a number of components that are known in the art. For example, the lid member 1 includes a first electrical attachment 10, and the vessel 5 includes a second electrical attachment 15. The electrical attachments 10, 15 preferably provide electrical communication between the lid member 1 and the vessel 5 when they are aligned with one another and further mated with one another.

The vessel 5 also preferably includes a control panel 20. The control panel 20 may serve as a means by which a user may input or otherwise select cooking modes. The control panel 20 may, for example, instruct the lid member 1 to carry out the below described mechanical operations to prepare the lid member 1 (and the vessel 5) to air fry or pressure cook food contained in the vessel 5.

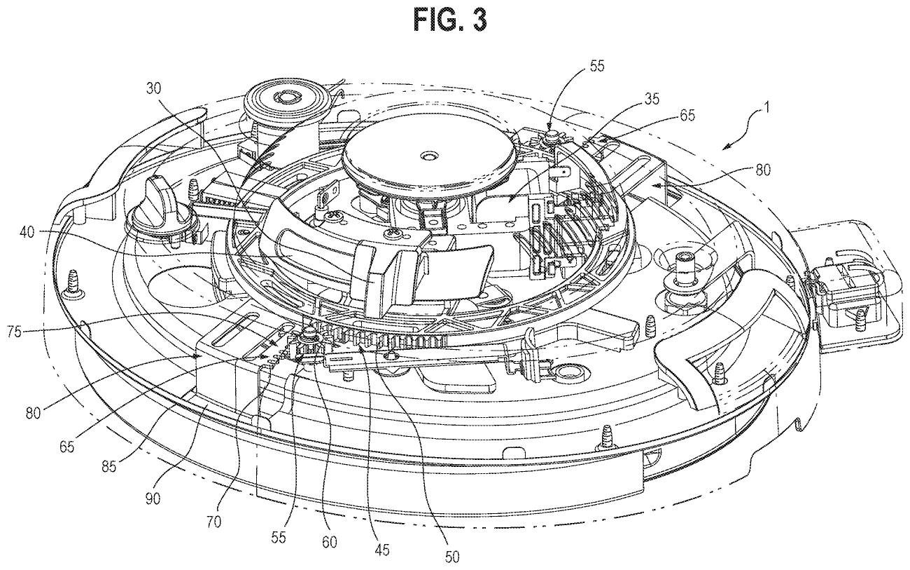

In FIGS. 1 and 2, the lid member 1 and the vessel 5 each include a casing 25 that keeps internal components covered. The casing 25 thus may protect components within the lid member 1 and the vessel 5 from operator error or errant debris. In a preferred embodiment, the casing 25 is constructed from a metal such as stainless steel, but may also be made from a material such as those known in the art such as plastic or the like to give the lid member 1 a more “finished” appearance. The lid member 1 is illustrated in FIGS. 3-8 without the casing 25 to better illustrate the various mechanical components within the lid member 1.

As illustrated in FIG. 3, the lid member 1 preferably includes a slider member 30 at an upper portion 35 thereof. The slider member 30 is preferably seated within a slot member 40 that allows the slider member 30 to slide from side to side within the slot member 40. The slider member 30 may be provided in a multitude of shapes or sizes, or it may be provided as an alternative activation member like those known in the art such as a handle, knob, button, or otherwise. The slider member 30 preferably acts as an activation member that sets into motion the various components described below that put the lid member 1 and the vessel 5 in condition to carry out its air frying or pressure cooking operations. In the embodiment illustrated in FIG. 3, the lid member 1 is in position to carry out the air frying function.

Below the slider member 30, the slider member 30 is preferably in mechanical connection with a first linear gear 45. The first linear gear 45 is a “rack” of a rack and pinion actuator that includes gear teeth 50 for engaging the gear teeth of a pinion (described below). In some embodiments, the first linear gear 45 and the slider member 30 may be integrally formed with one another. When a user slides the slider member 30 so that it slides within the slot member 40, the first linear gear 45 thus also slides/translates from side to side.

A circular gear 55 including gear teeth 60 is preferably in mechanical connection with the first linear gear 45. The circular gear 55 acts as the “pinion” in the rack and pinion system that the first linear gear 45 and the circular gear 55 represent. When the linear gear 45 translates, its gear teeth 50 engage the gear teeth 60 in the circular gear 55. The teeth 50, 60 work to convert the linear movement of the linear gear 45 into the circular rotational movement of the circular gear 55. More particularly, in the illustrated embodiment, as the slider member 30, and thus the first linear gear 45, move to the right, the circular gear 55 rotates in a clockwise direction.

The circular gear 55 is also in mechanical connection with a second linear gear 65 including gear teeth 70. The second linear gear 65 makes up a side portion 75 of a clamp member 80 that may secure (and unsecure) the lid member 1 to the vessel 5. When the circular gear 55 rotates as a function of the first linear gear 45 translating, the second linear gear 65 also translates. This not only causes the second linear 65 to translate inwardly, but also the clamp member 80 itself.

The clamp member 80 is preferably C-shaped so that they may clamp the lid member 1 to an upper portion of the vessel 5. The clamp member 80 may translate radially inwardly and outwardly so as to get closer to, and farther from, the vessel 5 as a user slides the slider member 30.

More particularly, when the clamp member 80 is drawn inwardly by pushing the slider mechanism to the right in the illustrated embodiment, it is drawn away from a lip member 85 provided around a circumference of the vessel 5. The clamp member 80 includes a foot member 90 at its lower portion that protrudes outwardly therefrom. As set forth below, when the lid member 1 is set to be in its pressure cooking mode, the foot member 90 may be positioned under the lip member 85 so that the lid member 1 may not be removed from the vessel 5.

It should be noted that in the embodiment illustrated herein, the lid member 1 includes two clamp members 80 on substantially opposite side of the lid member 1 from one another. As such, the lid member 1 also includes two first linear gears 45 (the second of which is obscured from view on FIG. 3), circular gears 55, and second linear gears 65. Preferably, the slider member is also in mechanical connection with the first linear gear 45 on the opposite side of the lid member 1. When the slider member 30 is moved to the right, both of the first linear gears 45 translate to the right and set into motion the above-described actions that ultimately result in the clamp members 80 drawn inwardly. In alternative embodiments, more or fewer clamp members 80, and gears 45, 55, 65, may be provided. In the embodiment described herein, the number of clamp members 55 and the number of respective gears 45, 55, 65, 35 are equal to one another.

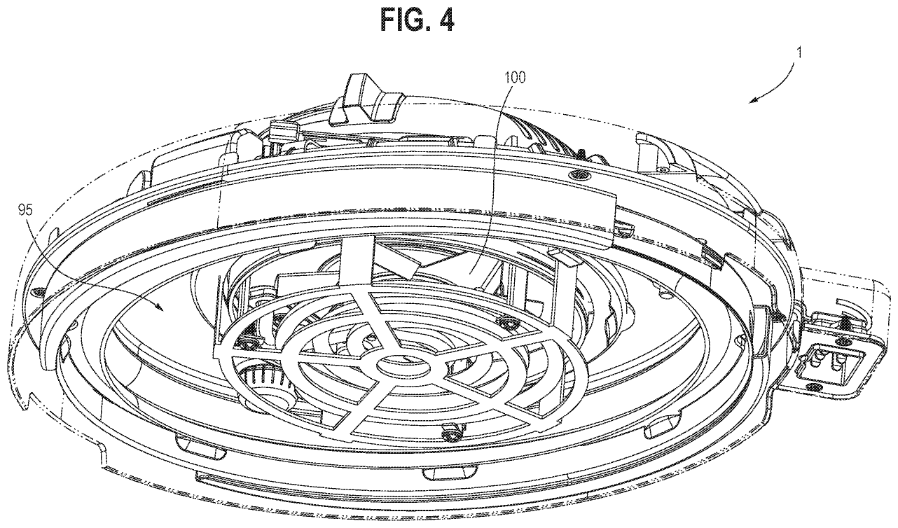

In the first position illustrated in FIGS. 3 and 4, with the firm attachment between the lid member 1 and the vessel 5 eliminated, air communication between the vessel 5 and the environment is created to help facilitate the air frying process. On an underside 95 of the lid member 1, a fan 100 is provided that helps circulate the air used during air frying.

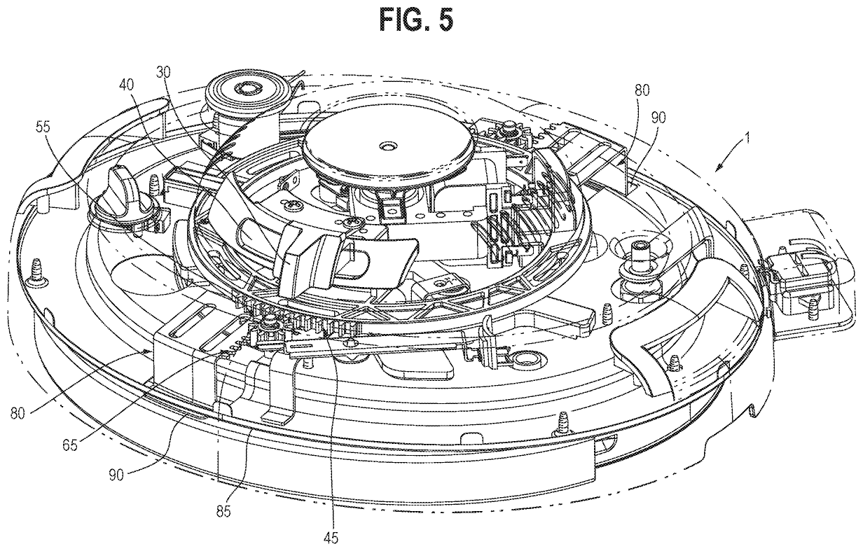

Turning to FIG. 5, the lid member 1 is shown in a transitional phase between its air frying and pressure cooking positions. More particularly, in FIG. 5, the slider member 30 is shown as having been translated at partially to the left within the slot member 40. As such, the first linear gear 45 has similarly been translated to the left, the circular gear 55 has rotated in the counterclockwise direction, and the second linear gear 65 and thus the clamp members 80 are translated radially outwardly so that their foot members 90 partially, but not completely, extend below the lip member 85 of the vessel 5. As such, in this position, the lid member 1 is secured to the vessel 5, but not secure that an airtight seal is formed capable of withstanding the pressures created by a pressure cooking operation.

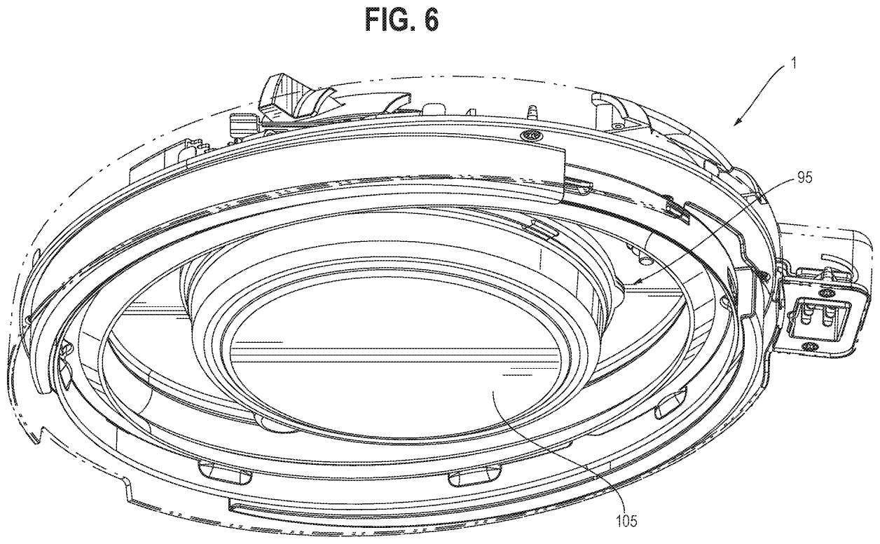

When the lid member 1 and vessel 5 are pressure cooking food within the vessel 5, the food may have a tendency to splatter as it is heated up. As such, the lid member 1 is preferably provided with a cap member 105 that is releasably attachable to the underside 95 of the lid member 1 to cover the fan 100. In FIG. 6, the cap member 105 is illustrated as attached to the underside 95 of the lid member 1 to protect the fan 100 from splatter. The cap member 105 may be attached to the lid member 1 in a number of ways, including but not limited to a mechanical connection like tabs or a friction fit, or even magnets. The cap member 105 is not required for the lid member 1 to operate, but it may help to maintain the fan 100 in working order while the lid member 1 is used to pressure cook food contained therein.

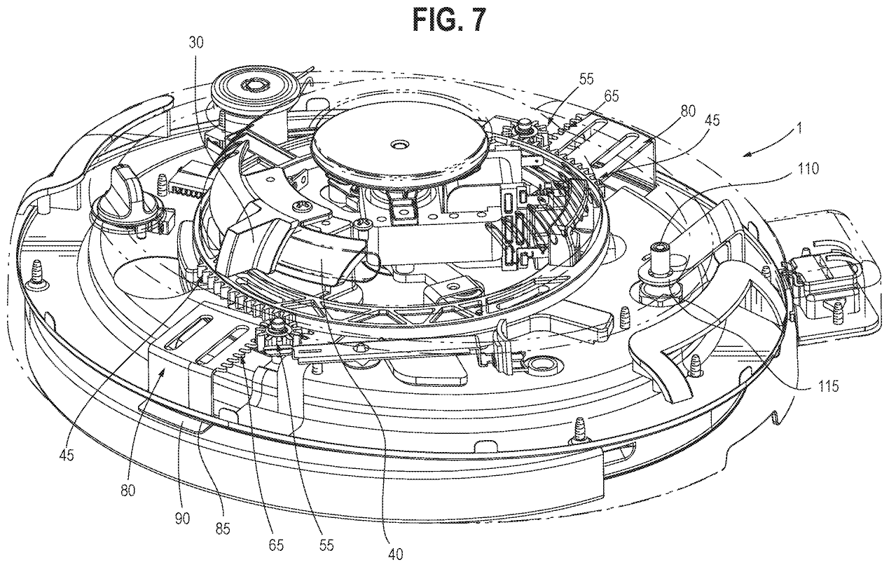

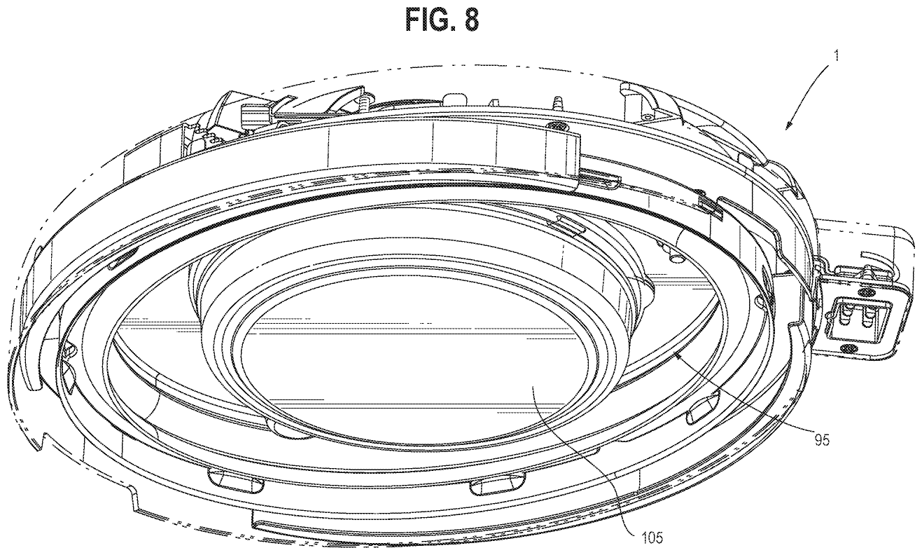

FIGS. 7 and 8 illustrate the lid member 1 in its pressure cooking position. In the pressure cooking position, the slider member 30 has been translated further or even completely to the left within the slot member 40. As described above, since the slider member has translated to the left, the first linear gear 45 has similarly been translated to the left. The circular gear 55 has further rotated in the counterclockwise direction, and the second linear gear 65 has translated outwardly, along with its associated clamp member 80 and its foot member 90. In this position, the foot member 90 has extended outwardly even farther below the lip member 85 of the vessel 5. In this position, the foot member 90 of the clamp member 80 is firmly secured below the lip member 85, thus securing the lid member 1 to the vessel 5 in an airtight manner. The clamp member 80 and its associated gear members 45, 55, 65 on the opposite end of the lid member from the illustrated clamp member 80 may operate similarly. In this position, because the seal between the vessel 5 and the lid member 1 is airtight, pressure cooking may be carried out.

When the lid member 1 and the vessel 5 are in its pressure cooking position, like other pressure cookers, the lid member 1 may include each of an indicator 110 and a through-hole 115. In operation, the indicator 110 is preferably in fluid communication with the inside of the vessel 5. The indicator 110 is preferably formed as a cylindrical tab that “pops up” when pressure is reached in the vessel 5. Such pressure may only be produced in the vessel 5 when the lid member 1 works with the vessel 5 to carry out its pressure cooking function. When the lid member 1 and the vessel 5 are in the pressure-cooking mode, with the slide member 30 slid to the left, and the clamp members 80 pushed outwardly, the indicator 110 may protrude through the through hole 115 when pressure is reached in the vessel 5.

Sensors may also be located in the lid member 1 or the vessel 5 that are able to detect when the lid member 1 is in the pressure cooking or air frying mode. The sensors may be in communication with a microcontroller that may instruct the lid member 1 to carry out particular functions associated with pressure cooking or air frying, depending on the position of the slider member 30, user input, or both.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An appliance capable of pressure cooking and air frying, the appliance including a lid for selective engagement with a vessel, the lid comprising:
an activation member that is slidable to move the lid between a pressure cooking position or an air frying position;
a clamp member in mechanical connection with the activation member;
wherein when the activation member is slid to a pressure cooking position, the clamp member is translated outwardly to engage a lip member of the vessel; and
wherein when the activation member is slid to an air frying position, the clamp member is translated inwardly to disengage the lip member of the vessel.

2. The lid of claim 1, wherein the lid includes a first linear gear in mechanical connection with the activation member, a rotary gear in mechanical connection with the first linear gear, and a second linear gear located on the clamp member, the second linear gear in mechanical connection with the rotary gear.

3. The lid of claim 1, wherein the clamp member includes a foot member that protrudes outwardly from the clamp member and slides under the lip member of the vessel when the activation member is in the pressure cooking position.

4. The lid of claim 1, wherein the lid includes two clamp members that secure the lid to the vessel when the activation member is slid to the pressure cooking position.

5. The lid of claim 1, wherein the lid includes a fan on an underside of the lid to carry out the air frying when the activation member is in the air frying position.

6. The lid of claim 5, wherein the lid includes a cap member that is selectively engageable with the underside of the lid to cover the fan when the activation member is in the pressure cooking position.

7. The lid of claim 1, wherein the activation member is a slider member.

8. A lid and vessel for an appliance capable of pressure cooking and air frying, the lid comprising:
an activation member that is slidable to place the lid in at least a first position or second position;
at least one clamp member in mechanical connection with the activation member, the at least one clamp member selectively engageable with the vessel;
wherein when the activation member is slid to the first position, the at least one clamp member disengages the lid from the vessel, and air communication is provided between the vessel and ambient air; and
wherein when the activation member is slid to the second position, the at least one clamp member engages the lid to the vessel.

9. The lid of claim 8, wherein a gear assembly mechanically connects the activation member to the at least one clamp member.

10. The lid of claim 9, wherein the gear assembly includes a first linear gear in mechanical connection with the activation member, a rotary gear in mechanical connection with the first linear gear, and a second linear gear located on the at least one clamp member, the second linear gear in mechanical connection with the rotary gear.

11. The lid of claim 10, wherein the lid includes a fan on an underside of the lid to carry out the air frying when the activation member is in the first position.

12. The lid of claim 11, wherein the lid includes a cap member that is selectively engageable with the underside of the lid to cover the fan when the activation member is in the second position.

13. The lid of claim 8, wherein the activation member is a slider member.

14. The lid of claim 8, wherein the first position is for air frying.

15. The lid of claim 8, wherein the second position is for pressure cooking.

16. A lid and vessel for an appliance capable of pressure cooking and air frying, the lid comprising:
an activation member that is slidable to place the lid in at least a first position or second position;
a first gear in mechanical connection with the activation member;
a clamp member in mechanical connection with the first gear;
wherein when the activation member is slid to the first position, the clamp member is radially translated inwardly to release the lid from the vessel; and
wherein when the activation member is slid to the second position, the clamp member is radially translated outwardly to secure the lid to the vessel.

17. The lid of claim 16, wherein the clamp member includes a foot member that projects outwardly therefrom and is engageable with a lip member of the vessel.

18. The lid of claim 16, wherein the activation member is a slider member.

19. The lid of claim 16, wherein the first position is for air frying.

20. The lid of claim 16, wherein the second position is for pressure cooking.
